(19) United States
(12) Patent Application Publication
(10) Pub. No.: US 2013/0040306 A1
(43) Pub. Date: Feb. 14, 2013

(54) BACKSCATTERING INTERFEROMETRIC ANALYSIS OF MEMBRANE MATERIALS

(71) Applicants: Darryl J. Bornhop, Nashville, TN (US); Michael Baksh, San Diego, CA (US); M.G. Finn, San Diego, CA (US); Amanda Kussrow, Nashville, TN (US)

(72) Inventors: Darryl J. Bornhop, Nashville, TN (US); Michael Baksh, San Diego, CA (US); M.G. Finn, San Diego, CA (US); Amanda Kussrow, Nashville, TN (US)

(21) Appl. No.: 13/409,557

(22) Filed: Mar. 1, 2012

Related U.S. Application Data
(60) Provisional application No. 61/447,802, filed on Mar. 1, 2011.

(51) Int. Cl. G01N 21/75

(52) U.S. Cl. 435/7.1

(57) ABSTRACT

Disclosed are improved optical detection methods comprising multiplexed interferometric detection systems and methods for determining a characteristic property of a sample, together with various applications of the disclosed techniques.

### CROSS-REFERENCE TO RELATED APPLICATIONS

This application claims priority to U.S. Provisional Patent Application No. 61/447,802, filed on Mar. 1, 2011, which is hereby incorporated by reference in its entirety.

### BACKGROUND

1. Technical Field

The present disclosure related to analysis methods, and specifically to backscattering interferometric analysis methods and devices for use therewith.

2. Technical Background

Capillary-based analysis schemes, biochemical analysis, basic research in the biological sciences such as localized pH determinations in tissues and studies in protein folding, detection and study of microorganisms, and the miniaturization of instrumentation down to the size of a chip all require small volume detection. With the advent of lasers, light sources possessing unique properties including high spatial coherence, monochromaticity and high photon flux, unparalleled sensitivity and selectivity in chemical analysis has become possible; these technologies, however, can be both expensive and difficult to implement. In contrast, refractive index (RI) detection has been successfully applied to several small volume analytical separation schemes. For various reasons, RI detection represents an attractive alternative to fluorescence and absorbance: it is relatively simple, it can be used with a wide range of buffer systems, and it is universal, theoretically allowing detection of any solute, making it particularly applicable to solutes with poor absorption or fluorescence properties.

Recently developed methods utilizing refractive indices have been useful for measurements, for example, to monitor biological interactions. Existing technologies can provide information on a variety of samples, but have limited capability to provide detailed information on membrane based interactions.

Accordingly, there is a need in the art for methods, systems, and apparatuses that can provide refractive index related measurements in membrane based materials.

### SUMMARY

As embodied and broadly described herein, the invention, in one aspect, relates to analysis methods, and specifically to backscattering interferometric analysis methods and devices for use therewith.

In one aspect, the invention relates to a method for determining a characteristic property of a sample, comprising the steps of providing an apparatus adapted for performing light scattering interferometry, the apparatus comprising a substrate, a channel formed in the substrate capable of receiving a sample to be analyzed, a light source for generating a light beam, a photodetector for receiving scattered light and generating a plurality of intensity signals; and at least one signal analyzer capable of receiving the intensity signals and determining therefrom one or more characteristic properties of the sample; and interrogating the using light scattering interferometry.

It will be apparent to those skilled in the art that various devices may be used to carry out the systems, methods, apparatuses, or computer program products of the present invention, including cell phones, personal digital assistants, wireless communication devices, personal computers, or dedicated hardware devices designed specifically to carry out aspects of the present invention. While aspects of the present invention may be described and claimed in a particular statutory class, such as the system statutory class, this is for convenience only and one of skill in the art will understand that each aspect of the present invention can be described and claimed in any statutory class, including systems, apparatuses, methods, and computer program products.

Unless otherwise expressly stated, it is in no way intended that any method or aspect set forth herein be construed as requiring that its steps be performed in a specific order. Accordingly, where a method, system, or computer program product claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 is a schematic block diagram of an interferometric detection system that is constructed in accordance with a first preferred aspect of the present invention.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which may need to be independently confirmed.

### DEFINITIONS

As used in the specification and the appended claims, the singular forms “a,” “an” and “the” include plural referents unless the context clearly dictates otherwise. Thus, for example, reference to “a substrate,” “a polymer,” or “a sample” includes mixtures of two or more such substrates, polymers, or samples, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where the event or circumstance occurs and instances where it does not.

As used herein, the term “polymer” refers to a relatively high molecular weight organic compound, natural or synthetic (e.g., polyethylene, rubber, cellulose), whose structure can be represented by a repeated small unit, the monomer (e.g., ethane, isoprene, β-glucose). Synthetic polymers are typically formed by addition or condensation polymerization of monomers.

As used herein, the term “copolymer” refers to a polymer formed from two or more different repeating units (monomer residues). By way of example and without limitation, a copolymer can be an alternating copolymer, a random copolymer, a block copolymer, or a graft copolymer.

As used herein, the term “bioassay” refers to a procedure for determining the concentration, purity, and/or biological activity of a substance.

As used herein, the term “chemical event” refers to a change in a physical or chemical property of an analyte in a sample that can be detected by the disclosed systems and methods. For example, a change in refractive index (RI), solute concentration and/or temperature can be a chemical event. As a further example, a biochemical binding or association (e.g., DNA hybridization) between two chemical or biological species can be a chemical event. As a further example, a disassociation of a complex or molecule can also be detected as an RI change. As a further example, a change in temperature, concentration, and association/dissociation can be observed as a function of time. As a further example, bioassays can be performed and can be used to observe a chemical event.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed.

This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Back Scattering Interferometry

Rapid monitoring and detection of ultra small volume samples is in great demand. One analytical approach, Back-Scattering Interferometry (BSI), derives from the observation that coherent light impinging on a cylindrically shaped capillary produces a highly modulated interference pattern. Typically, BSI analyzes reflections from a capillary tube filled with a liquid of which one wants to measure the refractive index. The technique has been shown capable of measuring changes in refractive index of liquids on the order of 10⁻⁹. The BSI technique is a simple and universal method of detecting refractive index changes in small volumes of liquid and can be applied to monitor changes in concentrations of solutes, flow rates and temperature, all conducted in nanoliter volumes.

The BSI technique is based on interference of laser light after it is reflected from different regions in a capillary or like sample container. Suitable methods and apparatus are described in U.S. Pat. No. 5,325,170 and WO-A-01/14858, which are hereby incorporated by reference. The reflected or back scattered light is viewed across a range of angles with respect to the laser light path. The reflections generate an interference pattern that moves in relation to such angles upon changing refractive index of the sample. The small angle interference pattern traditionally considered has a repetition frequency in the refractive index space that limits the ability to measure refractive index to refractive index changes causing one such repetition. In one aspect, such refractive index changes are typically on the order of three decades. In another aspect, such changes are on the order of many decades. In another aspect, the fringes can move over many decades up to, for example, the point where the refractive index of the fluid and the channel are matched.

BSI methods direct a coherent light beam along a light path to impinge on a first light transmissive material and pass there through, to pass through a sample which is to be the subject of the measurement, and to impinge on a further light transmissive material, the sample being located between the first and further materials, detecting reflected light over a range of angles with respect to the light path, the reflected light including reflections from interfaces between different substances including interfaces between the first material and the sample and between the sample and the further material which interfere to produce an interference pattern comprising alternating lighter and darker fringes spatially separated according to their angular position with respect to the light path, and conducting an analysis of the interference pattern to determine there from the refractive index, wherein the analysis comprises observation of a parameter of the interference pattern which is quantitatively related to sample refractive index dependent variations in the intensity of reflections of light which has passed through the sample.

The analysis comprises one or both of: (a) the observation of the angle with respect to the light path at which there is an abrupt change in the intensity of the lighter fringes, or (b) the observation of the position of these fringes of a low frequency component of the variation of intensity between the lighter and darker fringes. The first of these (a), relies upon the dependency of the angle at which total internal reflection occurs at an interface between the sample and the further material on the refractive index of the sample. The second (b), relies upon the dependency of the intensity of reflections from that interface on the refractive index as given by the Fresnel coefficients. The rectangular chips also have a single competent from diffraction at the corners.

The first material and the further material are usually composed of the same substance and may be opposite side walls of a container within which the sample is held or conducted. For instance, the sample may be contained in, e.g. flowed through, a capillary dimensioned flow channel such as a capillary tube. The side wall of the capillary tube nearer the light source is then the “first material” and the opposite side wall is the “further material.” The cross-sectional depth of the channel is limited only by the coherence length of the light and its breadth is limited only by the width of the light beam. Preferably, the depth of the channel is from 1 to 10 um, but it may be from 1 to 20 um or up to 50 um or more, e.g. up to 1 mm or more. However, sizes of up to 5 mm or 10 mm or more are possible. Suitably, the breadth of the channel is from 0.5 to 2 times its depth, e.g., equal to its depth.

Typically, at least one the interfaces involving the sample at which light is reflected is curved in a plane containing the light path, the curved interface being convex in the direction facing the incoming light if it is the interface between the first material and the sample and being concave in the direction facing the incoming light if it is the interface between the sample and the further material. The sample is typically a liquid, and can be flowing or stationary. However, the sample can also be a solid or a gas in various aspects of the present invention. The first and/or further materials will normally be solid but in principle can be liquid, e.g., can be formed by a sheathing flow of guidance liquid(s) in a microfluidic device, with the sample being a sheathed flow of liquid between such guidance flows. The sample may also be contained in a flow channel of appropriate dimensions in substrate such as a microfluidic chip. The method may therefore be employed to obtain a read out of the result of a reaction conducted on a “lab on a chip” type of device.

In contrast to conventional BSI techniques, the present invention provides systems, apparatuses, and methods for the analysis of membrane associated samples, solvents, and systems. In one aspect, the ability to analyze such systems can provide information on chemical and biological interactions previously only attainable by either destructive or complicated, time consuming methods.

### Preparation of Native Membrane Vesicle Samples

In one aspect, a sample can comprise one or more native membrane vesicles. The native membrane vesicle sample can be prepared from cultured animal cells or cell lines. Any animal cell or cell line can be used in the sample preparation methods described herein. For example, and not intending to be limiting, in one aspect the cells can be adherent cells, such as, for example, Chinese hamster ovary (CHO-K1) cells. In another aspect the cells can be suspension cells, such as suspension human T-lymphocytes (SUP-T1). In another aspect, CXCR4-positive cells, CXCR4-negative SUP-T1 cells, or a combination thereof can be used in the methods described herein. Additional cell lines that can be used in the methods described herein, include, but are not limited to, 293-T, 3T3, 721, 9L, A2780, A2780ADR, A2780cis, A172, A20, A253, A431, A-549, ALC, B16, B35, BCP-1, BEAS-2B, bEnd.3, BHK-21, BR 293, BxPC3, C3H-10T1/2, C6/36, Cal-27, CEM, CEM-SS, CHO, COR-L23, COR-L23/CPR, COR-L23/5010, COR-L23/R23, COS, COS-7, COV-434, CML T1, CMT, CT26, D17, DH82, DU145, DuCaP, EL4, EM2, EM3, EMT6/AR1, EMT6/AR10.0, FM3, H1299, H69, HB54, HB55, HCA2, HEK-293, HeLa, Hep-2, Hepa1c1c7, Hep-G2, HL-60, HMEC, HT-29, Huh-7, Jurkat, JY, K562, Ku812, KCL22, KG1, KYO1, LNCap, Ma-Mel 1, 2, 3 . . . 48, MC-38, MCF-7, MCF-10A, MDA-MB-231, MDA-MB-468, MDA-MB-435, MDCK, MDCK II, MOR/0.2R, MONO-MAC 6, MTD-1A, MyEnd, NCI-H69/CPR, NCI-H69/LX10, NCI-H69/LX20, NCI-H69/LX4, NIH-3T3, NALM-1, NW-145, OPCN, OPCT, Peer, PNT-1A, PNT 2, RenCa, RIN-5F, RMA/RMAS, Saos-2, Sf-9, SkBr3, T2, T-47D, T84, THP1, TZM-bl, U373, U87, U937, VCaP, Vero, WM39, WT-49, X63, YAC-1, YAR cells, or a combination thereof. The cells can be wild type cells or cells engineered to express specific proteins, including, but not limited to, full length transmembrane B-forms of both the rat and human gamma-aminobutyric acid receptor (GABAB) or zinc finger nuclease. Optionally, when the cultured cells are engineered to express a specific protein, the expression of the protein can be verified by Western immunoblotting using standard techniques known to a person of ordinary skill in the art. In yet another aspect the cells can be primary cells. Primary cells can be cells cultured directly from a subject. Primary cells can include, but are not limited to, human hepatocytes, primary fibroblasts, or peripheral blood mononuclear cells (PBMCs).

In one aspect the method of preparing native membrane vesicle samples can include obtaining a pre-cultured population of cells. As used herein, a “pre-cultured population of cells” can be a population of cells already grown to the proper concentrations suitable for use in the methods described herein. In another aspect the method of preparing native membrane vesicle samples from cultured cells can include the first step of growing, or culturing, the cells. The cultured cells can be adherent or suspension cells, and either type of cell can be cultured in any growth media appropriate for the cell or cell line being cultured. Growth media that can be used in the methods described herein includes, but is not limited to, RPMI 1640, MEM, DMEM, EMEM, F-10, F-12, Medium 199, MCDB131, or L-15. In one aspect the growth media can be supplemented with components that enhance cell growth. Media supplements that can be used in the methods described herein include, but are not limited to, animal serum, such as fetal bovine serum or fetal calf serum, animal digests, such as proteose peptone, buffers, amino acids, vitamins, antibiotics, or antifungal compounds. A person having ordinary skill in the art can readily determine the appropriate type of growth media and media supplements necessary to support the growth of the cell or cell line being cultured. Growth conditions can vary depending on the cell or cell line being cultured; however, generally, adherent cells can be grown at about 37° C. and about 5% ambient CO₂ to about 100% confluence for about three days once the cells are added to a cell culture flask. The cell culture flask can be a 25 cm², a 75 cm², a 150 cm², or a 175 cm²-area flask, or any other size flask used to culture cells or cell lines. In one aspect once adherent cells reach about 100% confluence, they can be harvested by removing all growth media from the flask and incubating with an appropriate volume of a cell detachment solution, such as Detachin solution or trypsin solution, for about 5 min at about 37° C. The appropriate volume of cell detachment solution can vary depending on the size of the cell culture flask being used. For example, and not to be limiting, about 3 mL of cell detachment solution can be used when cells are cultured in a 75 cm²-area flask, whereas about 4 mL cell detachment solution can be used when cells are cultured in a larger flask, such as a 150 cm² or a 175 cm²-area flask. About 50 mL of incubation buffer can then be added to the flask and the contents can be removed and transferred to two 50 mL centrifuge tubes. As used herein, a “centrifuge tube” can be any tapered tube of any size, which can be made of glass or plastic. The capacity of the centrifuge tube can be, but is not limited to, less than 100 μL, 100 μL, 200 μL, 250 μL, 500 μL, 1 mL, 2 mL, 2.5 mL, 5 mL, 10 mL, 15 mL, 25 mL, 50 mL, 100 mL, greater than 100 mL, or any capacity in between. A centrifuge tube can also be a microcentrifuge tube.

In another aspect suspension cells can be used in the methods described herein. Growth conditions can vary depending on the cell or cell line being cultured; however, generally, suspension cells can be grown at about 37° C. and about 5% ambient CO₂ to an approximate concentration of about 300,000 cells/mL, using growth media appropriate for the cell or cell line being cultured. The cell culture flask can be a 25 cm², a 75 cm², a 150 cm², or a 175 cm²-area flask, or any other size flask used to culture cells or cell lines. Once the adherent cells have been harvested or the suspension cells have reached a concentration of about 300,000 cells/mL, the cell solution can be centrifuged for about 5 min at about 300 g to pellet the cells; however, the time and rate of centrifugation can be adjusted according to the type of cell or cell line sample being prepared. Following centrifugation, the incubation buffer or media can be removed from the centrifuge tubes, the cells can be re-suspended in a buffer solution suitable for cell culture, for example, and not to be limiting, 1×PBS, and the cell/buffer suspension can be re-centrifuged. Cell pellets can be rinsed once, twice, three times, or more than three times in 1×PBS, each time being re-centrifuged, then can be used immediately to prepare native membrane vesicles for analysis using BSI.

In one aspect following centrifugation of the cultured cells, the cell pellet can be re-suspended in about 20 mL of ice-cold lysis buffer and placed on a rotator for about 45 minutes at about 4° C. Any lysis buffer known in the art can be used in the methods described herein. In one aspect the lysis buffer can comprise 2.5 mM NaCl, 1 mM Tris, and 1×EDTA-free broad-spectrum protease inhibitors, and can be at about pH 8.0. The cell pellet can contain about 10⁶ cultured cells. The resulting solution can then be centrifuged at about 40,000 g for about 60 min at about 4° C.; however, the time and rate of centrifugation can be adjusted according to the type of cell pellet sample being prepared. The supernatant can be removed and the pellet can be re-suspended in about 4 mL of ice-cold, buffer, for example, and not to be limiting, 1×PBS, then transferred to a new container. In one aspect the container can be a 5 mL glass dram vial. The pellet and buffer can then be sonicated to clarity in an ice bath and transferred to a centrifuge tube filter, for example, and not to be limiting, a 220 nm Millipore Ultrafree-MC centrifuge tube filter. Any means for sonication can be used in the methods described herein. For example, and not to be limiting, sonication can be applied using an ultrasonic bath, known as bath sonication, or an ultrasonic probe, known as probe sonication. The resulting solutions can be centrifuged for about 1 hour at about 16,000 g and about 4° C.; however, the time and rate of centrifugation can be adjusted according to the type of cell pellet sample being prepared. Native membrane vesicles can be collected by capturing the solution that passes through the centrifuge tube filter, and the sizes of the native membrane vesicles collected can be determined by dynamic light scattering. In one aspect, sizes of the native membrane vesicles can be determined using a Wyatt Technologies DynaPro dynamic light scattering apparatus. If not being analyzed by BSI immediately upon sample preparation, the native membrane vesicle samples can be stored at about 4° C. for about two days, then analyzed using BSI.

In another aspect, the native membrane vesicle sample can be prepared without the use of lysis buffer, wherein, following centrifugation of the cultured cells, the cell pellet can be re-suspended in about 20 mL of ice-cold buffer containing 1×EDTA-free broad spectrum protease inhibitors. The cell pellet can contain about 10⁶ cultured cells. The resulting solution can then be centrifuged at about 40,000 g for about 60 min at about 4° C.; however, the time and rate of centrifugation can be adjusted according to the type of cell pellet sample being prepared. The supernatant can be removed and the pellet can be re-suspended in about 4 mL of ice-cold, buffer, for example, and not to be limiting, 1×PBS, and then transferred to a new container. In one aspect the container can be a 5 mL glass dram vial. The pellet and buffer can then be sonicated to clarity in an ice bath and transferred to a centrifuge tube filter, for example, and not to be limiting, a 220 nm Millipore Ultrafree-MC centrifuge tube filter. Any means for sonication can be used in the methods described herein. For example, and not to be limiting, sonication can be applied using an ultrasonic bath, known as bath sonication, or an ultrasonic probe, known as probe sonication. The resulting solutions can be centrifuged for about 1 h at about 16,000 g and about 4° C.; however, the time and rate of centrifugation can be adjusted according to the type of pellet being used. Native membrane vesicles can be collected by capturing the solution that passes through the centrifuge tube filter, and the sizes of the native membrane vesicles collected can be determined by dynamic light scattering. In one aspect, sizes of the native membrane vesicles can be determined using a Wyatt Technologies DynaPro dynamic light scattering apparatus. If not being analyzed by BSI immediately upon sample preparation, the native membrane vesicle samples can be stored at about 4° C. for about two days, then analyzed using BSI.

### Preparing Synthetic Membrane Vesicle Samples for Analysis Using BSI

In another aspect the sample can comprise synthetic membranes. Small unilamellar vesicles (SUV) can be formed using standard techniques known in the art. For example, and not to be limiting, a lipid solution in chloroform can be evaporated in a flask, for example, and not to be limiting, a small round-bottom flask, and then hydrated for about 1 hour at about 4° C. in deionized (18.2 MW-cm) water, 0.5×PBS or 1×PBS at ˜3.3 mg/mL. Lipids that can be used in the methods described herein include, but are not limited to, 1,2-Dimyristoleoyl-sn-glycero-3-phosphocholine(DMOPC) and 1,2-dimyristoyl-sn-glycero-3-[phospho-L-serine] (sodium salt) (DMPS). In one aspect the deionized water can be Milli-Q deionized (18.2 MW-cm) water. The lipids can be sonicated to clarity in an ice-water bath and transferred to a centrifuge tube filter, for example, and not to be limiting, a 100 nm Millipore Ultrafree-MC centrifuge tube filter. Any means for sonication can be used in the methods described herein. For example, and not to be limiting, sonication can be applied using an ultrasonic bath, known as bath sonication, or an ultrasonic probe, known as probe sonication. Samples can then be centrifuged for about 2 hours at about 16,000 g and about 4° C.; however, the time and rate of centrifugation can be adjusted according to the type of synthetic membrane vesicle sample being prepared. Synthetic membrane vesicles can be collected by capturing the solution that passes through the centrifuge tube filter, and the sizes of the synthetic membrane vesicles collected can be determined by dynamic light scattering. In one aspect, sizes of the synthetic membrane vesicles can be determined using a Wyatt Technologies DynaPro dynamic light scattering apparatus. If not being analyzed using BSI immediately upon sample preparation, the synthetic membrane vesicle samples can be stored at about 4° C. for about one week.

In one aspect full-length fatty acid amide hydrolase (FAAH), a transmembrane protein important in neurological function and a drug target for pain management and other indications, can be incorporated into synthetic lipid vesicles by mixing FAAH, which can be reconstituted in 1% w/v n-octyl-beta-D-glucopyranoside (n-OG) in 1×PBS, and SUVs to a final concentration of about 100 μg of protein per mL of centrifuged SUV solution. The resulting mixture can then be dialyzed against either 1×PBS, pH 7.4 or 100 mM Tris pH 9.0 to facilitate complete removal of detergent. The size of the resulting proteoliposomes can be measured by dynamic light scattering. In one aspect the lipid:protein ratio can be about 3300:1. In yet another aspect the proteoliposomes can be about 150 nm in diameter. If not being analyzed by BSI immediately upon sample preparation, proteoliposomes can be stored at about 4° C. for about one week, then analyzed using BSI.

In other aspects, a sample can comprise one or more native membrane vesicle samples, one or more synthetic membrane vesicle samples, or a combination thereof. As described above, intermolecular interactions are fundamental in all aspects of chemistry and biochemistry.

The methods and techniques described herein can be performed for any system and/or analyte species. In another aspect, the BSI techniques described herein can be performed in an aqueous system, a non-aqueous system, or a mixture of aqueous and non-aqueous components. In another aspect, a solvent and/or sample can comprise a mixture of two or more solvents having the same or different polarities. In another aspect, a solvent mixture can be selected based on, for example, Hansen solubility parameters, so as to be compatible with one or more analytes of interest. In yet another aspect, the composition of a solvent can be adjusted during the course of an analysis so as to provide, for example, a gradient.

### Channel

The channel of the present invention can, in various aspects, be formed from a substrate such as a piece of silica or other suitable optically transmissive material. In one aspect, the material of composition of the substrate has a different index of refraction than that of the sample to be analyzed. In another aspect, as refractive index can vary significantly with temperature, the substrate can optionally be mounted and/or connected to a temperature control device. In yet another aspect, the substrate can be tilted, for example, about 7°, such that scattered light from channel can be directed to a detector.

In one aspect, the channel has a generally semi-circular cross-sectional shape. A unique multi-pass optical configuration is inherently created by the channel characteristics, and is based on the interaction of the unfocused laser beam and the curved surface of the channel that allows interferometric measurements in small volumes at high sensitivity. Alternatively, the channel can have a substantially circular or generally rectangular cross-sectional shape. In one aspect, the substrate and channel together comprise a capillary tube. In a further aspect, the substrate and channel together comprise a microfluidic device, for example, a silica substrate, or a polymeric substrate [e.g., polydimethylsiloxane (PDMS) or polymethyl methacrylate (PMMA)], and an etched channel formed in the substrate for reception of a sample, the channel having a cross sectional shape. In one aspect, the cross sectional shape of a channel is semi-circular. In another aspect, the cross sectional shape of a channel is square, rectangular, or elliptical. In other aspects, the cross sectional shape of a channel can comprise any shape suitable for use in a BSI technique. In another aspect, a substrate can comprise one or multiple channels of the same or varying dimensions. In various aspects, the channel can have a radius of from about 5 to about 250 micrometers, for example, about 5, 10, 20, 30, 40, 50, 75, 100, 150, 200, or 250 micrometers. In still other aspects, the channel can have a radius of up to about 1 millimeter or larger, such as, for example, 0.5 millimeters, 0.75 millimeters, 1 millimeter, 1.25 millimeters, 1.5 millimeters, 1.75 millimeters, 2 millimeters, or more.

In one aspect, a microfluidic channel, if present, can hold and/or transport the same or varying samples, and a mixing zone. The design of a mixing zone can allow at least initial mixing of, for example, one or more binding pair species. In another aspect, the at least initially mixed sample can then optionally be subjected to a stop-flow analysis, provided that the reaction and/or interaction between the binding pair species continues or is not complete at the time of analysis. The specific design of a microfluidic channel, mixing zone, and the conditions of mixing can vary, depending on such factors as, for example, the concentration, response, and volume of a sample and/or species, and one of skill in the art, in possession of this disclosure, could readily determine an appropriate design.

In one aspect, a channel comprises a single zone along its length for analysis. In another aspect, a channel can be divided into multiple discrete zones along the length of the channel, such as, for example, 2, 3, 4, 5, 6, 7, 8, 9, 10, or more zones. If a channel is divided into zones, any individual zone can have dimensions, such as, for example, length, the same as or different from any other zones along the same channel. In one aspect, at least two zones have the same length. In another aspect, all of the zones along a channel have the same or substantially the same length. In various aspects, each zone can have a length along the channel of from about 1 to about 1,000 micrometers, for example, about 1, 2, 3, 5, 8, 10, 20, 40, 80, 100, 200, 400, 800, or 1,000 micrometers. In other aspects, each zone can have a length of less than about 1 micrometer or greater than about 1,000 micrometer, and the present disclosure is not intended to be limited to any particular zone dimension. In one aspect, at least one zone can be used as a reference and/or experimental control. In yet another aspect, each measurement zone can be positioned adjacent to a reference zone, such that the channel comprises alternating measurement and reference zones. It should be noted that the zones along a channel do not need to be specifically marked or delineated, only that the system be capable of addressing and detecting scattered light from each zone.

In another aspect, any one or more zones in a channel can be separated from any other zones by a junction, such as, for example, a union, coupling, tee, injection port, mixing port, or a combination thereof. For example, one or more zones in the flow path of a sample can be positioned upstream of an injection port where, for example, an analyte can be introduced. In such an aspect, one or more zones can also be positioned downstream of the injection port.

In yet another aspect, a channel can be divided into two, three, or more regions, wherein each region is separated from other regions by a separator. In one aspect, a separator can prevent a fluid in one region of a channel from contacting and/or mixing with a fluid from another region of the channel. In another aspect, any combination of regions or all of the regions can be positioned such that they will be impinged with at least a portion of the light beam. In such an aspect, multiple regions of a single channel can be used to conduct multiple analyses of the same of different type in a single instrumental setup. In one aspect, a channel has two regions, wherein a separator is positioned in the channel between the two regions, and wherein each of the regions are at least partially in an area of the channel where the light beam is incident.

In one aspect, if multiple regions are present, each region can have an input and an output port. In one aspect, the input and/or output ports can be configured so as not to interfere with the generation of scattered light, such as, for example, backscattered light, and the resulting measurements. It should be noted that other geometric designs and configurations can be utilized, and the present invention is not intended to be limited to the specific exemplary configurations disclosed herein. Thus, in one aspect, a single channel can allow for analysis of multiple samples simultaneously in the same physical environment.

In one aspect, a separator, if present, comprises a material that does not adversely affect detection in each of the separated regions, such as, for example, by creating spurious light reflections and refractions. In one aspect, a separator is optically transparent. In another aspect, a separator does not reflect light from the light source. In such an aspect, a separator can have a flat black, non-reflective surface. In yet another aspect, the separator can have the same or substantially the same index of refraction as the channel. In yet another aspect, a separator can be thin, such as, for example, less than about 2 μm, less than about 1 μm, less than about 0.75 μm.

Any one or more individual zones along a channel, or any portion of a channel can optionally comprise a marker compound positioned within the path of the channel. In one aspect, a marker compound can be positioned on the interior surface of a capillary such that a sample, when introduced into the channel, can contact and/or interact with the marker compound.

A marker compound, if present, can comprise any compound capable of reacting or interacting with a sample or an analyte species of interest. In one aspect, a marker compound can comprise a chromophore. In another aspect, a marker compound can comprise a ligand that can interact with a species of interest to provide a detectable change in refractive index.

### Light Source

In one aspect, the light source generates an easy to align optical beam that is incident on the etched channel for generating scattered light. In another aspect, the light source generates an optical beam that is collimated, such as, for example, the light emitted from a HeNe laser. In another aspect, the light source generates an optical beam that is not well collimated and disperses in, for example, a Gaussian profile, such as that generated by a diode laser. In another aspect, at least a portion of the light beam is incident on the channel such that the intensity of the light on any one or more zones is the same or substantially the same.

In another aspect, the portion of the light beam incident on the channel can have a non-Gaussian profile, such as, for example, a plateau (e.g., top-hat). The portion of the light beam in the wings of the Gaussian intensity profile can be incident upon other portions of the channel or can be directed elsewhere. In one aspect, variations in light intensity across the channel can result in measurement errors. In still another aspect, if portions of a light beam having varying intensity are incident upon multiple zones or portions of a channel, a calibration can be performed wherein the expected intensity of light, resulting interaction, and scattering is determined for correlation of future measurements.

The light source can comprise any suitable equipment and/or means for generating light, provided that the frequency and intensity of the generated light are sufficient to interact with a sample and/or a marker compound and provide elongated fringe patterns as described herein. Light sources, such as HeNe lasers and diode lasers, are commercially available and one of skill in the art could readily select an appropriate light source for use with the systems and methods of the present invention. In one aspect, a light source can comprise a single laser. In another aspect, a light source can comprise two or more lasers, each generating a beam that can impinge one or more zones of a channel. In another aspect, if two or more lasers are present, any individual laser can be the same as or different from any other laser. For example, two individual lasers can be utilized, each producing a light beam having different properties, such as, for example, wavelength, such that different interactions can be determined in each zone along a channel.

As with any interferometric technique for micro-chemical analysis, it can be advantageous, in various aspects, for the light source to have monochromaticity and a high photon flux. If warranted, the intensity of a light source, such as a laser, can be reduced using neutral density filters.

The systems and methods of the present invention can optionally comprise an optical element that can focus, disperse, split, and/or raster a light beam. In one aspect, an optical element, if present, can at least partially focus a light beam onto a portion of the channel. In various aspects, such an optical element can facilitate contact of the light beam with one or more zones along a channel. In one aspect, a light source, such as a diode laser, generates a light beam having a Gaussian profile, and an optical element is not necessary or present. In another aspect, a light source, such as a diode laser, can be used together with an optical focusing element. In another aspect, a light source, such as a HeNe laser, generates a collimated light beam and an optical element can be present to spread the light beam and facilitate contact of the light beam with at least two zones along the channel. Such a light beam configuration can allow for multiple measurements or sample and reference measurements to be made simultaneously or substantially simultaneously within the same channel.

In various aspects, an optical element, if present, can comprise a dispersing element, such as a cylindrical lens, capable of dispersing the light beam in at least one direction; a beam splitting element capable of splitting a well collimated light beam into two or more individual beams, each of which can be incident upon a separate zone on the same channel; a rastering element capable of rastering a light beam across one or more zones of a channel; or a combination thereof.

In yet other aspects, one or more additional optical components can be present, such as, for example, a minor, a neutral density filter, or a combination thereof, so as to direct the light beam and/or the scattered light in a desired direction or to adjust one or more properties of a light beam.

### Impingement

At the channel, the light beam should have a profile such that the light beam impinges the channel in the area of interest. In one aspect, the light beam impinges the channel over a single zone or portion of the channel. In another aspect, the light beam impinges the channel over multiple, for example, 2, 3, 4, or more zones. In one aspect, the intensity of the light beam is uniform or substantially uniform across each of the discrete zones of interest along the channel. In another aspect, the light beam is dimensioned so as to fill or slightly overfill the channel or at least that portion of the channel to be interrogated. In another aspect, the light beam is aligned such that it impinges the channel perpendicular to the central axis of the channel. In yet another aspect, the width of the light beam is parallel to the longitudinal axis of the channel.

In another aspect, the alignment of the light beam exhibits no or substantially no tilt or skew with respect to the channel. In one aspect, the alignment of the light beam and the capillary can be such that the resulting fringe patterns are positioned above or below the incoming beam. In one aspect, misalignment or poor alignment of the light beam with the channel can result in distorted and/or skewed interference fringes due to the uneven distribution of light beam energy at the point of impingement with the channel.

Other than alignment of the light beam with respect to the channel, the position and orientation of the light source, optional optical element, channel, and detector, can vary according to a particular experimental design, provided that scattered light can be generated by reflective and refractive interactions of the light beam with the substrate/channel interface, sample, and optional marker compounds. One of skill in the art in possession of this disclosure could readily determine an appropriate arrangement of the light source, optional optical element, channel, and detector.

When incident upon a channel having a sample therein, and optionally one or more marker compounds positioned in zones along the channel, the incident light can scatter and comprise elongated interference fringes due to reflective and refractive interaction with the sample, channel walls, and marker compounds, if present. These elongated fringe patterns can comprise a plurality of light bands whose positions shift as the refractive index of the sample is varied, either through compositional changes or through temperature changes, for example. In one aspect, the scattered light comprises backscattered light. In another aspect, the optical elements and channel can be positioned so as to result in side scattering of the light beam. In yet another aspect, the optical elements and channel can be positioned to measure light passed through a channel, such as, for example, when using a fluorescent analyte or probe species, or an absorbing species.

### Detector

A detector detects the scattered light and converts it into intensity signals that vary as the positions of the light bands in the elongated fringe patterns shift, and can thus be employed to determine the refractive index (RI), or an RI related characteristic property, of the sample. The detector can, in various aspects, comprise any suitable image sensing device, such as, for example, a bi-cell sensor, a linear or area array CCD or CMOS camera and laser beam analyzer assembly, a photodetector assembly, an avalanche photodiode, or other suitable photodetection device. In one aspect, the detector is a photodetector. In another aspect, the detector is an array photodetector capable of detecting multiple interference fringe patterns. In yet another aspect, a detector can comprise multiple individual detectors to detect interference fringe patterns produced by the interaction of the light beam with the sample, channel wall, and optional marker compounds. In one aspect, the scattered light incident upon the detector comprises interference fringe patterns. In another aspect, the scattered light incident upon the detector comprises elongated interference fringe patterns that correspond to the discrete zones along the length of the channel. The specific position of the detector can vary depending upon the arrangement of other elements. In one aspect, the detector can be positioned at an approximately 45° angle to the channel.

The intensity signals from the detector can then be directed to a signal analyzer for fringe pattern analysis and determination of the RI or RI related characteristic property of the sample and/or reference in each zone of the channel. The signal analyzer can be a computer or a dedicated electrical circuit. In one aspect, the signal analyzer includes the programming or circuitry necessary to determine from the intensity signals, the RI or other characteristic property of the sample in each discrete zone of interest. In another aspect, the signal analyzer is capable of detecting positional shifts in interference fringe patterns and correlating those positional shifts with a change in the refractive index of at least a portion of the sample. In another aspect, the signal analyzer is capable of detecting positional shifts in interference fringe patterns and correlating those positional shifts with a change in the refractive index occurring in a portion of the channel. In yet another aspect, the signal analyzer is capable of comparing data received from a detector and determining the refractive index and/or a characteristic property of the sample in any zone or portion of the channel.

In other aspects, the signal analyzer is capable of interpreting an intensity signal received from a detector and determining one or more characteristic properties of the sample. In still other aspects, the signal analyzer can utilize a mathematical algorithm to interpret positional shifts in the interference fringe patterns incident on a detector. In another aspect, known mathematical algorithms and/or signal analysis software, such as, for example, deconvolution algorithms, can be utilized to interpret positional shifts occurring from a multiplexed scattering interferometric analysis.

The detector can be employed for any application that requires interferometric measurements; however, the detector can be particularly useful for making universal solute quantification, temperature and flow rate measurements. In these applications, the detector provides ultra-high sensitivity due to the multi-pass optical configuration of the channel. In the temperature measuring aspect, a signal analyzer receives the signals generated by the photodetector and analyzes them using the principle that the refractive index of the sample varies proportionally to its temperature. In this manner, the signal analyzer can calculate temperature changes in the sample from positional shifts in the detected interference fringe patterns. In one aspect, the ability to detect interference fringe patterns from interactions occurring along a channel can provide real-time reference and/or comparative measurements without the problem of changing conditions between measurements. In one aspect, a signal analyzer, such as a computer or an electrical circuit, can thus be employed to analyze the photodetector signals, and determine the characteristic property of the sample.

In the flow measuring aspect, the same principle is also employed by the signal analyzer to identify a point in time at which perturbation is detected in a flow stream in the channel. In the case of a thermal perturbation, a flow stream whose flow rate is to be determined, is locally heated at a point that is known distance along the channel from the detection zone. The signal analyzer for this aspect includes a timing means or circuit that notes the time at which the flow stream heating occurs. Then, the signal analyzer determines from the positional shifts of the light bands in the interference fringe patterns, the time at which thermal perturbation in the flow stream arrives at the detection zone. The signal analyzer can then determine the flow rate from the time interval and distance values. Other perturbations to the flow stream, include, but are not limited to, introduction into the stream of small physical objects, such as glass microbeads or nanoparticles. Heating of gold particles in response to a chemical reaction or by the change in absorption of light due to surface-bound solutes or the capture of targets contained within the solution can be used to enhance the temperature induced RI perturbation and thus to interrogate the composition of the sample. In another aspect, measurements at multiple zones along the channel can be used to determine temperature gradients or rate of temperature change of a sample within the channel.

In one aspect, the systems and methods of the present invention can be used to obtain multiple measurements simultaneously or substantially simultaneously from discrete zones along the length of a channel. In such an aspect, each zone can provide a unique measurement and/or reference. For example, a series of reactive species can be used as marker compounds, positioned in zones along the channel, each separated by a reference zone. In another aspect, temporal detection can be used to measure changes in a sample over time as the sample flows through the channel, for example, with a flow injection analysis system.

In another aspect, two or more samples, blanks, and/or references can be positioned in the channel such that they are separated by, for example, an air bubble. In another aspect, each of a plurality of samples and/or reference species can exhibit a polarity and/or refractive index the same as or different from any other samples and/or reference species. In one aspect, a pipette can be used to place a portion of a reference compound into the channel. Upon removal of the pipette, an air bubble can be inserted between the portion of the reference compound in the channel and a portion of a sample compound, thereby separating the reference and sample compounds and allowing for detection of each in a flowing stream within the channel. In another aspect, each sample and/or reference compound can be separated by a substance other than air, such as, for example, water, oil, or other solvent having a polarity such that the sample and/or reference compounds are not miscible therewith.

In one aspect, the sample is a fluid. In another aspect, the sample is a liquid, which can be a substantially pure liquid, a solution, or a mixture. In a further aspect, the sample can further comprise one or more analytes. In one aspect, a sample can be introduced into the channel via an injection port at, for example, one end of the channel.

As the light beam impinges one or more discrete regions of a channel, the resulting interference fringe patterns can move with a change in refractive index. The ability to analyze multiple discrete zones simultaneously can provide high spatial resolution and can provide measurement techniques with an integrated reference.

### Interferometric Detection System

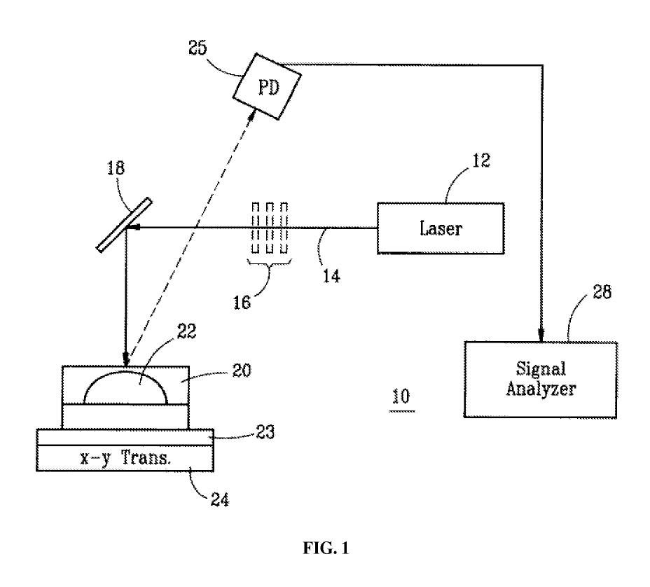

In one aspect, the invention relates to an interferometric detection system and method that can be used, for example, for detection of refractive index changes in picoliter sized volumes for chip-scale analyses. Conventional backscattering interferometry, as illustrated in FIG. 1, utilizes interference fringes generated by backscattered light to detect refractive index changes in a sample. The backscatter detection technique is generally disclosed in U.S. Pat. No. 5,325,170 to Bornhop, and U.S. Patent Publication No. US2009/0103091 to Bornhop, both of which are hereby incorporated by reference. With reference to FIG. 1, a conventional backscattering interferometric detection system 10 comprises a laser 12 that produces a light beam 14. The light beam can be directed through one or more neutral density filters 16 to reduce the intensity of the light beam, before being reflected on a mirror 18 and directed to impinge an etched channel 22 on a chip 20. The chip can also be positioned on a temperature controlled support block 23 and/or an X-Y translation stage 24. After various reflective and refractive interactions with the channel and sample, the scattered light can be directed to a detector 25, and the intensity signals generated by the detector interpreted by a computer based signal analyzer 28.

In another aspect, the inventive interferometric detection system and methods are capable of measuring multiple signals, for example, along a length of a capillary channel, simultaneously or substantially simultaneously. In one aspect and while not wishing to be bound by theory, the refractive index changes that can be measured by the multiplexed interferometric detection systems and methods of the present disclosure can arise from molecular dipole alterations associated with conformational changes of sample-ligand interaction as well as density fluctuations.

The detection system has numerous applications, including the observation and quantification of membrane-associated protein binding events, molecular interactions, molecular concentrations, ligand-metal interactions, electrochemical reactions, ultra micro calorimetry, flow rate sensing, and temperature sensing. In another aspect the invention relates to methods of preparing a sample for quantifying ligand-receptor binding interactions using backscattering interferometry.

In one aspect, the detection systems and methods described herein can be useful as a bench-top molecular interaction photometer. In another aspect, the detection systems and methods described herein can be useful for performing bench-top or on-site analysis.

In another aspect, the interferometric detection system comprises a substrate, a channel formed in the substrate for reception of a sample to be analyzed, a light source for generating a light beam, directing the light beam onto the substrate such that the light beam is incident on at least a portion of the channel and thereby generate scattered light through reflective and refractive interaction of the light beam with a substrate/channel interface and the sample, the scattered light comprising interference fringe patterns, a photodetector for receiving scattered light from each of the two or more discrete zones and generating a plurality of intensity signals, and at least one signal analyzer for receiving the intensity signals and determining therefrom one or more characteristic properties of the sample along the length of the channel.

### Interferometric Detection Methods

In one aspect, the present invention provides a method for determining a characteristic property of a sample comprising the steps of providing an apparatus adapted for performing light scattering interferometry, the apparatus comprising a substrate, a channel formed in the substrate capable of receiving a sample to be analyzed, a light source for generating a light beam, a photodetector for receiving scattered light and generating a plurality of intensity signals, and at least one signal analyzer capable of receiving the intensity signals and determining therefrom one or more characteristic properties of the sample, and interrogating the sample using light scattering interferometry.

As in conventional BSI, the inventive methods, in one aspect, monitor a change in refractive index to determine the binding affinity of molecular interactions. In such an aspect, the introduction of two binding partners into the channel can create a change in refractive index, resulting in a spatial shift in the generated fringe pattern. In one aspect, the magnitude of this shift depends on the precise fringes interrogated, the concentration of the binding pairs, conformational changes initiated upon binding, changes in water of hydration, and binding affinity.

When compared to the concentrations and volumes used for ITC and ellipsometry, BSI is 6 orders of magnitude more sensitive than ITC and 8 orders of magnitude more than ellipsometry. This makes BSI interaction-efficient, with the ability to detect a relatively small number of discreet interactions when compared to other free-solution techniques. The simple, user-friendly design of BSI provides a technique by which organic chemists can screen for molecules by following a change in refractive index.

### Detection of Chemical Events

The disclosed systems and methods can be used in connection with the detection and determination of a wide variety of characteristic properties of a sample. For example, the invention can be used to determine absolute or relative refractive index (RI) of a sample, for example a fluid either flowing or static. The disclosed systems and methods can also be used in connection with detection and determination of chemical events, for example the formation of hydrogen bonds in an organic reaction.

In one aspect, the disclosed systems and methods can be used to analyze membrane associated events, such as, for example, a membrane associated protein binding event.

### Analytical Detection Events

In one aspect, the invention also finds use as a detector for other chip-scale analytical schemes including chromatographic separations and FIA. In another aspect, it is possible to detect catalyst species and their interaction with chemical reactants. In another aspect, the interferometric techniques can be used to quantify environmental analytes. In yet another aspect, micro-thermometry can be performed, wherein the device has the capability of measuring small temperature changes (in the 10⁻³° C. range) allowing for calorimetry and fundamental chemical binding studies to be performed in picoliter volumes.

### Determination of Kinetic Parameters

In a further aspect, BSI can determine kinetic parameters. That is, the interferometric detection technique described herein can be used to monitor various kinetic parameters, such as, for example, binding affinities, of a chemical and/or biochemical analyte species. The use of BSI for the determination of a kinetic parameter can provide one or more advantages over traditional techniques, for example, free-solution measurements of label-free species, high throughput, small sample volume, high sensitivity, and broad dynamic range. A BSI technique can be performed on a free-solution species, a surface immobilized species, or a combination thereof. In one aspect, the species of interest is a free-solution species, wherein at least a portion of the species of interest is not bound or otherwise immobilized. In another aspect, at least a portion of the species of interest is surface immobilized.

In one aspect, a BSI technique can be used to analyze and/or quantify one or more molecular interactions, such as, for example, a dissociation constant for one or more binding pair species.

The sensitivity of a multiplexed BSI technique can allow analysis and/or determination of at least one kinetic parameter to be performed on a small volume sample. The volume of a sample comprising at least one species of interest can, in various aspects, be less than about 1 mL, for example, about 900, 850, 800, 700, 600, 500, 400, 350, 300, 250, or 200 pL; less than about 600 pL, for example, about 580, 550, 500, 450, 400, 350, 300, 250, or 200 pL; or less than about 400 pL, for example, about 390, 380, 370, 360, 350, 340, 330, 320, 310, 300, 280, 250, 230, or 200 pL. In one aspect, the sample volume is about 500 pL. In another aspect, the sample volume is about 350 pL. The sample volume can also be greater than or less than the volumes described above, depending on the concentration of a species of interest and the design of a particular BSI apparatus. A species that can be analyzed via BSI can be present in neat form, in diluted form, such as, for example, in a dilute solution, or any other form suitable for analysis by a BSI technique. The concentration of a species of interest can likewise vary depending upon, for example, the design of a particular BSI apparatus, the volume of sample in the optical path, the intensity of a response of a specific species to the radiation used in the experiment. In various aspects, the species can be present at a concentration of from about 1 pM to greater than 100 mM.

Analysis of a kinetic parameter via a BSI technique can be performed on a static sample, a flowing sample, for example, 75-120 μL/min, or a combination thereof. In another aspect, analysis of a kinetic parameter via a BSI technique can be performed on a flowing sample having a flow rate of, for example, 10-1,000 nl/min, or less. In one aspect, an analysis can be a stop-flow determination that can allow an estimation of the dissociation constant (K_{D}) of one or more binding pairs of species. The speed at which one or more samples can be analyzed can be dependent upon, inter alia, the data acquisition and/or processing speed of the detector element and/or processing electronics.

The concentration of one or more analyte species in a sample can be determined with a BSI technique by, for example, monitoring the refractive index of a sample solution comprising an analyte species. A property, such as, for example, refractive index, can be measured in real-time and the kinetics of an interaction between analyte species determined therefrom. Other experimental conditions, such as, for example, temperature and pH, can optionally be controlled during analysis. The number of real-time data points acquired for determination of a kinetic parameter can vary based on, for example, the acquisition rate and the desired precision of a resulting kinetic parameter. The length of time of a specific experiment should be sufficient to allow acquisition of at least the minimal number of data points to calculate and/or determine a kinetic parameter. In one aspect, an experiment can be performed in about 60 seconds.

An apparent binding affinity between binding pair species can subsequently be extracted from the acquired data using conventional kinetics models and/or calculations. In one aspect, a model assumes first order kinetics (a single mode binding) and the observed rate (k_{obs}) can be plotted versus the concentration of one of the species. A desired kinetic parameter, such as, for example, K_{D}, can be determined by, for example, a least squares analysis of the relationship plotted above. A suitable fitting model can be selected based on the particular experimental condition such that a rate approximation can be determined at the end of the analysis. One of skill in the art can readily select an appropriate model or calculation to determine a particular kinetic parameter from data obtained via BSI analysis.

In one aspect, BSI can be utilized to measure a free-solution molecular interaction. In another aspect, BSI can be used to measure both a free solution property and a immobilized interaction within the same channel. In a further aspect, BSI can measure label-free molecular interactions.

BSI can be used in any market where measuring macromolecular interactions is desired. In one aspect, a BSI technique, as described herein can be combined with various electrochemical studies. In summary, BSI can be useful as a tool for studying small molecule interactions.

### EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

### Preparation of Native Membrane Vesicle Samples for BSI Analysis

In a first example, two different lines of adherent Chinese hamster ovary (CHO-K1) cells were used; one wild-type, and one engineered to express the full length transmembrane B-forms of both the rat and human gamma-aminobutyric acid receptor (GABA_{B}). The engineered cell CHO-K1 cell line was designated b12.2. Two different lines of suspension human T-lymphocytes (SUP-T1) cells were also used; one wild-type (CXCR4-positive) and one engineered to express a zinc finger nuclease (CXCR4-negative). Adherent cells were grown at 37° C. and 5% ambient CO₂ to near 100% confluence over three days from initial addition to 175 cm²-area flasks. Adherent cells were harvested by removing all growth medium from the flask and incubating with 4 mL of Detachin solution for 5 min at 37° C. Incubation buffer (48 mL) was then added to the flask and the contents were removed and transferred to two 50 mL centrifuge tubes. Suspension cells were grown to an approximate concentration of 300,000 cells/mL. In both cases, the cells and media were centrifuged for 5 min at 300 g to pellet the cells. Following centrifugation, the media was removed from the centrifuge tubes, the cells were re-suspended in 1×PBS, and the cell/PBS suspension was re-centrifuged. Cell pellets were rinsed three times in 1×PBS and used immediately. The expression of the GABA_{B} receptor in membranes derived from the b12.2 cells was verified by Western immunoblotting.

A cell pellet containing approximately 10⁶ cells of either adherent or suspension cells was re-suspended in 20 mL of ice-cold lysis buffer (2.5 mM NaCl, 1 mM Tris, 1×EDTA-free, broad-spectrum protease inhibitors, at pH 8.0) and placed on a rotator for 45 minutes at 4° C. The resulting solution was then centrifuged at 40,000 g for 60 min at 4° C. The supernatant was removed and re-suspended in 4 mL of ice-cold 1×PBS and transferred to a 5 mL glass dram vial. The pellet and buffer were then probe-sonicated to clarity in an ice bath and transferred to a 220 nm Millipore Ultrafree-MC centrifuge tube filter. The resulting solutions were centrifuged for 1 h at 16,000 g and 4° C. All solution that passed through the centrifuge tube filter was collected and stored at 4° C. for up to two days. Sizes of both synthetic and native membrane vesicles was determined using a Wyatt Technologies DynaPro dynamic light scattering apparatus.

### Example 2

### Preparation of Synthetic Membrane Vesicle Samples for BSI Analysis

The lipids-1,2-Dimyristoleoyl-sn-glycero-3-phosphocholine(DMOPC) and 1,2-dimyristoyl-sn-glycero-3-[phospho-L-serine] (sodium salt) (DMPS), were received in chloroform and stored at −20° C. for up to two weeks. Small unilamellar vesicles (SUV) were formed using standard techniques. A lipid solution in chloroform was evaporated in small round-bottom flasks and hydrated for an hour at 4° C. in Milli-Q deionized (18.2 MW-cm) water, 0.5×PBS or 1×PBS at ˜3.3 mg/mL. The lipids were probe-sonicated to clarity in an ice-water bath and transferred to a 100 nm Millipore Ultrafree-MC centrifuge tube filter. Samples were centrifuged for 2 h at 16,000 g and 4° C. All solution that passed through the centrifuge tube filter was collected and stored at 4° C. for up to one week. Full-length, purified, lyophilized, fatty acid amide hydrolase (FAAH) was reconstituted in 1% w/v n-octyl-beta-D-glucopyranoside (n-OG) in 1×PBS. Full-length FAAH was incorporated into synthetic lipid vesicles by mixing FAAH and SUVs to a final concentration of 100 μg of protein per mL of centrifuged SUV solution. The resulting mixture was then dialyzed extensively against either 1×PBS, pH 7.4 or 100 mM Tris pH 9.0 to facilitate complete removal of detergent. The resulting proteoliposomes were approximately 150 nm in diameter, as measured by DLS, with an estimated lipid:protein ratio of approximately 3300:1. Proteoliposomes were stored at 4° C. for up to one week.

### Example 3

### Determining the Mechanism of Action and Approximate Binding Site for Distinct Classes of Small Molecule PLD Inhibitors

In a third example, classic and novel biochemical techniques were utilized to measure in vitro kinetic parameters of mammalian phospholipase D (PLD) in order to characterize the mechanism of action of small molecule inhibitors and to facilitate determining the approximate small molecule site of action. PLD is an evolutionarily conserved phosphodiesterase that catalyses the hydrolysis of phosphatidylcholine (PC), producing the critical structural and signaling lipid phosphatidic acid (PA). Beyond facilitating lipid bilayer curvature for membrane fusion events, PA acts as a signaling node, recruiting Sos and Raf to the membrane, as well as allosterically regulating NFκB and mTOR, and serving as precursor to other lipid second messengers lysophosphatidic acid and diacylglycerol. Aberrant PLD activity and disregulated PA production have been implicated in a number of disease states, including cancer, viral infection and replication, and immune response and inflammation. PLD is composed of four conserved domains: Phox homology (PX) and pleckstrin homology (PH) lipid binding domains at the amino terminus are thought to serve a regulatory function; two conserved HKD (histidine, lysine, aspartate) motifs within the bilobal catalytic domain, separated by a thermolabile loop region of variable length and a polybasic phosphatidylinositol-4,5-bisphosphate (PIP₂) binding region. Two isoforms have been identified, PLD1 and PLD2, that maintain 50% sequence identity, most of which exists within the conserved catalytic domain. PLD1 is largely cytosolic and has low basal activity until recruited to the membrane upon a signaling event, while PLD2 maintains high basal activity and is constitutively localized to the membrane. The two isoforms are predicted to act at distinct points in cell signaling pathways, but the activity of the two isoforms has been difficult to distinguish due to the lack of potent and isoform-selective small molecule inhibitors. Historically, siRNA and primary alcohols have been the only tools available for studying the role of PLD in signaling pathways. PLD-linked PA production is blocked by treatment with a primary alcohol, which exploits the transphosphatidylation reaction characteristic of PLD-family members, in which the primary alcohol is the preferred nucleophile to water during PC hydrolysis.

While the in vitro activity of purified PLD1 has been demonstrated, the specific mechanism of inhibition is unknown. With the inventive techniques and methods described herein, kinetic studies of this enzyme can be being performed to determine whether compounds compete for substrate binding or allosterically inhibit the enzyme. This mechanism can thus be compared to that of other reported classes of direct PLD inhibitors, including tungstate and the selective estrogen receptor modulators (SERMs), raloxifene and tamoxifen.

Eukaryotic PLD is an interfacial enzyme that, in the classic model, binds the lipid surface via interaction with PI(4,5)P₂ prior to hydrolyzing substrate. The substrate is not freely soluble and the enzyme cannot randomly diffuse through solution and encounter substrate, therefore classic Michaelis-Menten assumptions do not apply. In order to study PLD, the interfacial binding affinity must first be measured (Kₛ), and subsequent studies must saturate lipid binding to force application of Michaelis-Menten kinetics.

Small molecule binding studies demonstrate whether compounds act directly on the enzyme in the absence of lipid. Protein constructs that are composed of different domains of the enzyme are thus used to determine the approximate site of small molecule interaction. The bulk of the studies performed thus far use human PLD1c.d311, an amino-terminally-truncated and catalytically active construct that has robust expression in SF21 insect cells, and can be purified to homogeneity over a single affinity chromatography step. This construct does retain a small portion of the pleckstrin homology domain that is necessary for catalytic activity of the enzyme (reason for this is unknown).

Binding studies are performed using backscattering interferometry (BSI), which can be performed on an efficient nanoscale level with a picomolar limit of detection, and can be used to measure Kᵢ and Kₛ values for inhibitor-treated purified protein.

In vitro activity assays can be performed to measure changes in Kₘ, and Vₘₐₓ due to small molecule inhibition. This reconstitution assay uses large unilamellar vesicles (generated by extrusion of defined % mol amounts of purified lipid species) incubated with purified PLD and measures the release of a tritiated choline headgroup as a readout of catalytic activity.

For the backscattering interferometry experiments, large-unilamellar lipid vesicles are generated via extrusion for use in interfacial kinetic studies. The composition generally includes 86% mol neutral diluent (36:2 PE or 36:2 PG), 5% mol PI(4,5)P₂, and 8% mol 32:0 PC. Following extrusion, bulk lipid concentration is confirmed via quantitative LC/MS. A HeNe laser beam is then directed at a sample in the channel of a microfluidic chip, resulting in an interference fringe pattern that is detected by the CCD camera. This fringe pattern shifts spatially as the refractive index (RI) of the sample changes; these shifts are translated into a numerical change in phase of the corresponding Fourier transformation. The absolute value of the magnitude in phase change corresponds to the change in solvation/hydration of the protein upon binding ligand, and can be used to plot a ligand binding curve. This inventive BSI technique can also accurately and reproducibly measure protein-lipid binding. This technique measures small shifts in RI phase (limit of sensitivity is picomolar) and requires only nanomolar concentrations of protein and ligand in a 1 μl volume channel.

BSI has been used to measure Kᵢ for PLD1c.d311 and VU-series inhibitors in the absence of lipid. These binding affinities are consistent with IC₅₀'s generated in the in vitro activity assays. This data confirms that the VU-series inhibitors do in fact bind purified enzyme directly, and that this binding affinity closely matches inhibitory concentrations of compound.

Small molecule binding curves were also generated for two representative SERMs, raloxifene and tamoxifen. These compounds were confirmed to be PLD inhibitors in vitro. However, BSI measurements demonstrate that the mechanism of inhibition for these SERMs is very different. Consistent with reports on other PI(4,5)P₂-dependent proteins, tamoxifen appears to indirectly inhibit PLD activity, likely through binding PI(4,5)P₂ and altering phospholipid fluidity, thereby blocking interaction with the lipid interface; whereas raloxifene directly binds the enzyme and directly inhibits PLD activity by shifting Kₛ.

Concentration response curves were generated in a radioisotopically labelled activity assay for three VU-series compounds and tungstate with N-myr-Arf1 activated PLD1.d311. Kᵢ measurements of these inhibitors were obtained using BSI. These binding affinities are roughly on the same scale (within 2-fold) as IC₅₀s, and show PLD1.d311 directly binds the inhibitors in the absence of lipid.

Both tamoxifen and raloxifene inhibit in vitro PLD activity, with IC₅₀s of 48 μM and 10 μM, respectively; however, small molecule binding studies generated using BSI demonstrate that these two compounds must be inhibiting enzyme activity differently. Raloxifene directly binds the enzyme in the absence of lipid, while tamoxifen does not bind purified PLD 1c.d311. Further data suggests raloxifene directly binds the enzyme and shifts Kₛ.

BSI can also be used to measure changes in lipid binding affinities due to small molecule treatment. BSI-derived values can be compared to Kₛ values determined using classic biochemical methods.

BSI was used to measure K_{d} of two VU-series compounds for albumin in the absence of lipid. These results are consistent with preliminary DMPK plasma protein studies, where VU0359595 (EVJ) was shown to be 98% plasma protein bound. For compounds that bind albumin (VU0359595, or EVJ), Kₛ is disrupted compared to vehicle. For compounds that do not bind albumin (VU40355-1, or 1154), Kₛ does not shift from vehicle. As another control to confirm that vesicle composition is not disrupted due to small molecule treatment, K_{d} and Kₛ are measured for PLCδ1, which binds PIP₂ at both its PH and catalytic domains. PLCδ1 does not bind VUO359595 (EVJ) and does not show shifted Kₛ from that of vehicle.

In summary, backscattering interferometry has been demonstrated as a nanoscale technique for measuring binding affinities for protein-ligand complexes and can efficiently be applied to measure protein-lipid binding affinities.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for determining a characteristic property of a sample comprising the steps of:
a. preparing a sample comprising one or more membrane vesicles;
b. providing an apparatus adapted for performing light scattering interferometry, the apparatus comprising
i. a substrate;
ii. a channel formed in the substrate capable of receiving the sample to be analyzed;
iii. a light source for generating a light beam;
iv. a photodetector for receiving scattered light and generating intensity signals; and
v. at least one signal analyzer capable of receiving the intensity signals and determining therefrom one or more characteristic properties of the sample; and
c. interrogating the sample using light scattering interferometry.

2. The method of claim 1, wherein the sample comprises a native membrane vesicle.

3. The method of claim 2, wherein the sample comprises cultured animal cells or cell lines.

4. The method of claim 1, wherein the sample comprises a synthetic membrane vesicle.

5. The method of claim 1, wherein interrogating comprises detecting scattered light on the photodetector, and wherein the scattered light comprises a plurality of interference fringe patterns.

6. The method of claim 1, wherein interrogating comprises detecting backscattered light on the photodetector, and wherein the scattered light comprises a plurality of interference fringe patterns.

7. The method of claim 1, wherein interrogating comprises monitoring a membrane associated protein binding event.

8. The method of claim 1, wherein the light source comprises a HeNe laser.

9. The method of claim 1, wherein the light source comprises a diode laser.

10. The method of claim 1, wherein the sample is interrogated in at least two discrete locations along a length of the channel substantially simultaneously.

11. The method of claim 1, further comprising determining one or more characteristic properties of the sample from the intensity signals.

12. The method of claim 11, wherein at least one of the one or more characteristic properties comprises a change in conformation, structure, charge, level of hydration, or a combination thereof.

13. The method of claim 1, wherein the sample comprises a plurality of individual sample and/or reference compounds, each separated by a volume of air in the channel.

14. A method for determining a characteristic property of a sample comprising the steps of:
a. preparing a sample comprising one or more membrane vesicles;
a. providing a substrate having a channel formed therein for reception of a sample to be analyzed;
b. introducing a sample to be analyzed into the channel;
c. directing a light beam from a light source onto the substrate such that the light beam is incident on at least a portion of the sample to generate scattered light through reflective and refractive interaction of the light beam with a substrate/channel interface, and the sample, wherein the scattered light comprising interference fringe patterns including a plurality of spaced light bands whose positions shift in response to changes in the refractive index of the sample;
d. detecting positional shifts in the light bands; and
e. determining the characteristic property of the sample from the positional shifts of the light bands in the interference fringe patterns.

15. The method of claim 14, wherein the scattered light is incident on a photodetector array.

16. The method of claim 14, wherein e) comprises determining a plurality of characteristic properties of the sample from the interference fringe patterns generated in the channel.

17. The method of claim 14, wherein the positional shifts in the light bands correspond to a chemical event occurring in the sample.

18. The method of claim 14, wherein the substrate and channel together comprise a capillary tube.

19. The method of claim 14, wherein the substrate and channel together comprise a microfluidic device.

20. The method of claim 19, wherein the microfluidic device comprises a silica substrate and an etched channel formed in the substrate for reception of a sample, the channel having a cross sectional shape.
